(19) United States
(12) Patent Application Publication
(10) Pub. No.: US 2011/0273426 A1
(43) Pub. Date: Nov. 10, 2011

(54) Apparatus and method for driving e-paper panel

(75) Inventor: Oh-Jo Kwon, Suwon-si (KR)

(73) Assignee: SAMSUNG ELECTRO-MECHANICS CO., LTD., Suwon (KR)

(21) Appl. No.: 12/805,593

(22) Filed: Aug. 6, 2010

(30) Foreign Application Priority Data
May 6, 2010 (KR) 10-2010-0042447

(51) Int. Cl. G09G 5/00

(52) U.S. Cl. 345/212

(57) ABSTRACT

Disclosed herein are an apparatus and a method for driving an e-paper panel. The e-paper panel driving apparatus includes a power supply module that supplies a DC power, a DC/DC converter that converts voltage of the DC power supply supplied from the power supply module into a preset voltage, a sensing module that senses an output voltage from the DC/DC converter, and a control module that supplies or blocks the output voltage from the DC/DC converter to an e-paper panel according to the output voltage sensed by the sensing module.

### CROSS REFERENCE TO RELATED APPLICATION

This application claims the benefit of Korean Patent Application No. 10-2010-0042447, filed on May 6, 2010, entitled “Apparatus and method for driving e-paper panel”, which is hereby incorporated by reference in its entirety into this application.

### BACKGROUND OF THE INVENTION

1. Technical Field

The present invention relates to an e-paper display, and more particularly, to a driving power supply technology of an e-paper panel.

2. Description of the Related Art

Recently, an electronic paper has been introduced into various kinds of fields in order to replace paper made of existing cellulose pulp. The electronic paper is advantageous in that it looks similar as being printed on a general paper with ink, it is foldable or bendable different from a flat display, and it does not consume additional power after displaying an image at one time.

Despite such advantages, an e-paper display is mainly used in a mobile apparatus driven by a battery, such that various researches have been conducted in order to effectively reduce power consumption by optimizing a driving circuit of an e-paper panel.

### SUMMARY OF THE INVENTION

An object of the present invention is to prevent an image quality of an e-paper panel from being degraded due to unstable power supply, while simultaneously minimizing unnecessary power consumption of an e-paper panel driving apparatus.

According to an exemplary embodiment of the present invention, there is provided an e-paper panel driving apparatus, including: a power supply module that supplies a DC power; a DC/DC converter that converts voltage of the DC power supply supplied from the power supply module into a preset voltage; a sensing module that senses an output voltage from the DC/DC converter; and a control module that supplies or blocks the output voltage from the DC/DC converter to an e-paper panel according to the output voltage sensed by the sensing module.

At this time, when the sensing module determines that the output voltage value from the DC/DC converter is equal to the preset voltage value, it may output an output enable signal.

When the control module receives the output enable signal from the sensing module, it may supply the output voltage from the DC/DC converter to the e-paper panel.

Meanwhile, according to an exemplary embodiment of the present invention, there is provided a method for driving an e-paper panel, including: sensing an output voltage from a DC/DC converter, in an e-paper panel driving apparatus; determining whether the sensed output voltage value is equal to a preset value, in the e-paper panel driving apparatus; and supplying the output voltage to an e-paper panel, when the output voltage value is equal to the preset value, in the e-paper panel driving apparatus.

At this time, the determining may include outputting an output enable signal when it is determined that the output voltage value from the DC/DC converter is equal to the preset voltage value.

Further, the supplying the output voltage may supply the output voltage from the DC/DC converter to the e-paper panel when the output enable signal is output at the determining.

### BRIEF DESCRIPTION OF THE DRAWINGS

FIG. 1 is a block diagram of an e-paper panel driving apparatus 100 according to an embodiment of the present invention;

FIGS. 2 and 3 are graphs explaining an operation of an e-paper panel driving apparatus 100 according to an embodiment of the present invention; and

FIG. 4 is a flow chart showing a method for driving an e-paper panel 400 according to an embodiment of the present invention.

### DESCRIPTION OF THE PREFERRED EMBODIMENTS

Hereinafter, exemplary embodiments of the present invention will be described with reference to the accompanying drawings. However, the exemplary embodiments are described by way of examples only and the present invention is not limited thereto.

In describing the present invention, detailed description of well-known technology relating to the present invention may unnecessarily make unclear the spirit of the present invention, the detailed description is not provided. Further, the following terminologies are defined in consideration of the functions in the present invention and may be construed in different ways by the intention of users and operators. Therefore, the definition should be made on the basis of the description of the specification. Therefore, the definitions thereof should be construed based on the contents throughout the specification.

As a result, the spirit of the present invention is determined by the claims and the following exemplary embodiments may be provided to efficiently describe the spirit of the present invention to those skilled in the art.

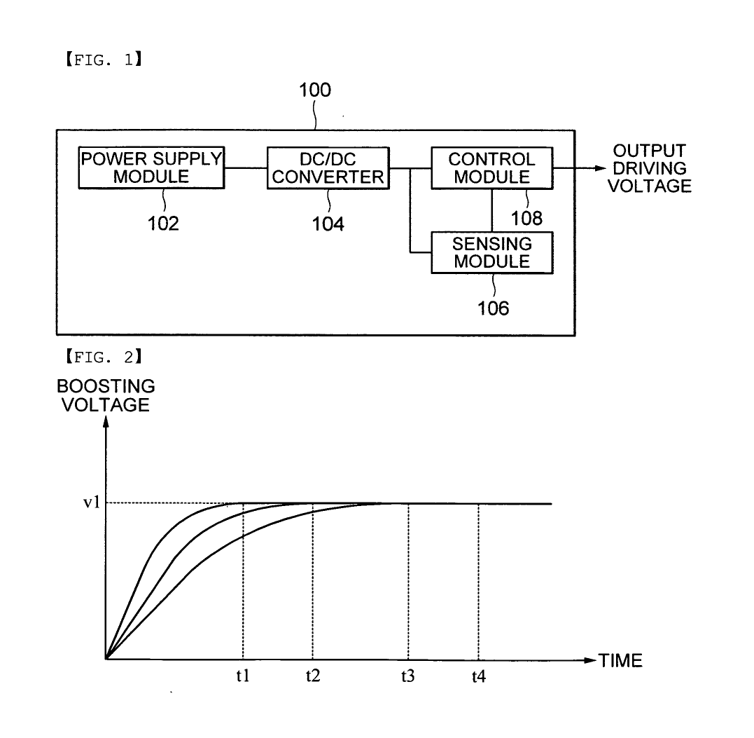

FIG. 1 is a block diagram of an e-paper panel driving apparatus 100 according to an embodiment of the present invention.

The e-paper panel driving apparatus 100 shown in the figure is an apparatus that supplies driving voltage to an e-paper panel (not shown). In general, the e-paper panel requires power of 15V or more in order to drive thereof and thus, the e-paper panel driving apparatus 100 makes driving voltage required for the e-paper panel by boosting power voltage.

As shown in FIG. 1, the e-paper panel driving apparatus 100 according to an embodiment of the present invention includes a power supply module 102, a DC/DC converter 104, a sensing module 106, and a control module 108.

The power supply module 102, which supplies DC power for driving the e-paper panel, may, for example, be configured of a rechargeable or non-rechargeable battery.

The DC/DC converter 104 converts the voltage of the DC power supply supplied from the power supply module 102 into a preset voltage. The magnitude of the voltage converted and output by the DC/DC convert 104 is determined according to the type of e-paper panels that are connected to the e-paper panel driving apparatus 100.

The sensing module 106 senses the output voltage converted and output by the DC/DC converter 104 to determine whether the voltage conversion by the DC/DC converter 104 is completed. More specifically, the sensing module 106 compares the magnitude of the output voltage from the DC/DC convert 104 with a preset value to determine whether the voltage conversion by the DC/DC converter 104 is completed. When the voltage value sensed by the sensing module 106 is equal to the preset value, it is determined that the voltage conversion is completed, and when the voltage value sensed by the sensing module 106 is larger or smaller than the preset value, it is determined that the voltage conversion is not completed. The preset value is determined according to the driving voltage of the e-paper panel.

When the voltage conversion by the DC/DC converter 104 is completed, that is, when the sensed voltage value reaches the preset value, the sensing module 106 outputs an output enable signal. For example, the sensing module 106 may be configured to output a low signal before the voltage conversion by the DC/DC converter 104 is completed and output a high signal when the voltage conversion by the DC/DC converter 104 is completed. In this case, the output enable signal becomes the high signal. To the contrary, the sensing module 106 may be configured to output a high signal before the voltage conversion by the DC/DC converter 104 is completed and output a low signal when the voltage conversion by the DC/DC converter 104 is completed. In this case, the output enable signal becomes the low signal.

The control module 108 supplies or blocks the voltage output from the DC/DC converter 104 to the e-paper panel. The control module 108 blocks the voltage output from the DC/DC convert 104 from being supplied to the e-paper panel before it receives the output enable signal from the sensing module 106, that is, before the voltage conversion by the DC/DC converter is completed. The control module 108 supplies the output voltage to the e-paper panel when it is determined that the voltage conversion by the DC/DC converter 104 is completed, that is, when it receives the output enable signal from the sensing module 106.

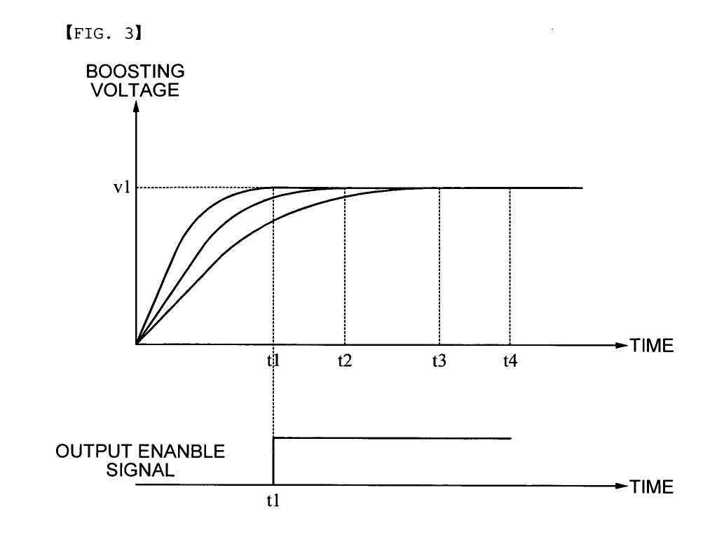

FIGS. 2 and 3 are graphs explaining an operation of an e-paper panel driving apparatus 100 according to an embodiment of the present invention.

As described above, in order to drive an e-paper panel, power of 15V or more is required according to the type of e-paper panels. Therefore, a separate DC/DC converter is used in the e-paper panel driving apparatus as shown in FIG. 1, thereby making a driving voltage for driving the e-paper panel.

However, even though the driving voltage is generated using the same type of DC/DC converters, the time taken to output a desired driving voltage is not the same. The time (an initial driving time) taken to output the desired driving voltage from the DC/DC converter varies according to efficiency of the DC/DC converter, characteristics of the e-paper panel, state of a power supply (battery), and so on. FIG. 2 shows the output voltages from the DC/DC converters of three e-paper driving apparatuses each connected to different e-paper panels, wherein it may be appreciated that they reach the desired driving voltage v1 at time t1, t2, and t3, respectively.

In the case of a general e-paper panel driving apparatus, driving voltage is supplied to the e-paper panel after a sufficient time (for example, t4) elapses in consideration of the difference in the initial driving time of the DC/DC converter. In this case, however, a predetermined time should elapse even when the voltage conversion by the DC/DC converter is completed, such that unnecessary power consumption occurs. That is, in the case of the e-paper panel driving apparatus of which voltage conversion is completed at time t1, unnecessary power consumption by time t4−t1 is made.

To the contrary, when the driving voltage is supplied from the e-paper panel driving apparatus before the voltage conversion is completed, for example, when the driving voltage is output, at time t2, from the e-paper panel driving apparatus of which voltage conversion is completed at time t3, a voltage for driving the e-paper panel is insufficiently supplied, thereby outputting an abnormal image to the e-paper panel.

In the present invention, however, when the voltage conversion is completed in the DC/DC converter, which is sensed to generate an output enable signal and a driving voltage is supplied to the e-paper panel according to the output enable signal, as shown in FIG. 3. Therefore, according to the present invention, it is possible to prevent an image quality from being degraded due to unstable voltage conversion, while simultaneously minimizing unnecessary power consumption. FIG. 3 shows an embodiment in which the output enable signal is output when the voltage conversion is completed at time t1.

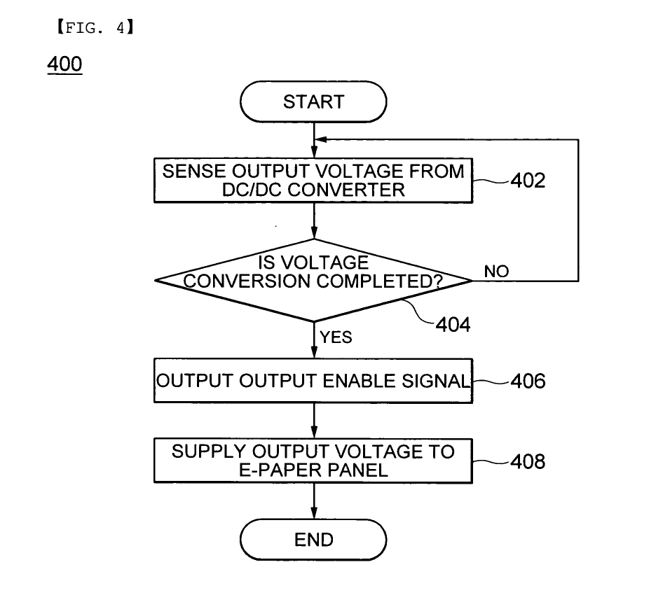

FIG. 4 is a flow chart showing a method for driving an e-paper panel 400 according to an embodiment of the present invention.

First, when a DC power is applied to a DC/DC converter 104, a sensing module 106 senses an output voltage from the DC/DC converter 104 (402), and determines whether a voltage conversion is completed in the DC/DC converter 104 (404). The completion of the voltage conversion is determined based on whether the sensed output voltage value is equal to a preset voltage, that is, a driving voltage value of an e-paper panel.

When the sensing module 106 determines that the voltage conversion is completed in the DC/DC converter 104, the sensing module 106 outputs an output enable signal (406), and a control module receives the output enable signal to supply the output voltage from the DC/DC converter 104 to the e-paper panel (408).

According to the present invention, the driving voltage is supplied to the e-paper panel right after the output voltage conversion is completed by sensing the time point when the output voltage conversion by the DC/DC converter, to be supplied to the e-paper panel, is completed, such that it is possible to prevent an image quality of the e-paper panel from being degraded due to unstable power supply, while simultaneously minimizing unnecessary power consumption of the e-paper panel driving apparatus.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

Accordingly, the scope of the present invention is not construed as being limited to the described embodiments but is defined by the appended claims as well as equivalents thereto.

What is claimed is:

1. An e-paper panel driving apparatus, comprising:
a power supply module that supplies a DC power;
a DC/DC converter that converts voltage of the DC power supply supplied from the power supply module into a preset voltage;
a sensing module that senses an output voltage from the DC/DC converter; and
a control module that supplies or blocks the output voltage from the DC/DC converter to an e-paper panel according to the output voltage sensed by the sensing module.

2. The e-paper panel driving apparatus according to claim 1, wherein when the sensing module determines that the output voltage value from the DC/DC converter is equal to the preset voltage value, it outputs an output enable signal.

3. The e-paper panel driving apparatus according to claim 2, wherein when the control module receives the output enable signal from the sensing module, it supplies the output voltage from the DC/DC converter to the e-paper panel.

4. A method for driving an e-paper panel, comprising:
sensing an output voltage from a DC/DC converter, in an e-paper panel driving apparatus;
determining whether the sensed output voltage value is equal to a preset value, in the e-paper panel driving apparatus; and
supplying the output voltage to an e-paper panel, when the output voltage value is equal to the preset value, in the e-paper panel driving apparatus.

5. The method for driving an e-paper panel according to claim 4, wherein the determining includes outputting an output enable signal when it is determined that the output voltage value from the DC/DC converter is equal to the preset voltage value.

6. The method for driving an e-paper panel according to claim 5, wherein the supplying the output voltage supplies the output voltage from the DC/DC converter to the e-paper panel when the output enable signal is output at the determining.
